(19) United States
(12) Patent Application Publication
(10) Pub. No.: US 2002/0096940 A1
(43) Pub. Date: Jul. 25, 2002

(54) CONTROL SYSTEM FOR ELECTRICALLY DRIVEN FUNCTIONAL UNITS IN MOTOR VEHICLES

(76) Inventors: HEINRICH LANG, ERGERSHEIM (DE); WOLFGANG SEIBOTH, BAD WINDSHEIM (DE)

Correspondence Address: JEFFREY M KARMLOVICH, DORITY & MANNING P A, P O BOX 1449, GREENVILLE, SC, 296021449

(21) Appl. No.: 09/406,519

(22) Filed: Sep. 28, 1999

(30) Foreign Application Priority Data
May 27, 1999 (DE) 199 24 301.8

(51) Int. Cl. B60L 1/00

(52) U.S. Cl. 307/10.1

(57) ABSTRACT

Made available is a control system for electrically driven functional elements in motor vehicles, such as central locking, window operation, outside mirrors and the like and which control system possesses a master control and a plurality of subordinate controls connected to said master control. Such a system is achieved, wherein a master control governs a plurality of subordinate controls, when one master control is placed at the driver's convenience at a central position, and a plurality of electrically driven functional elements in the motor vehicle can be operated, activated and controlled.

### DESCRIPTION

The invention concerns a control system for electrically driven functional units in motor vehicles. Such functions include central door locking, window operator mechanisms, outside rear view mirror adjustments, and the like.

Generally, in motor vehicles, as well as in commercial vehicles and passenger cars, there is a growing aspect of electrically operated facilities, including central door locking, electrical window operation mechanisms, adjustable outside rear view mirrors, sun-roof openings and the like. A practical connection and interlinking of the operating elements which belong to this class of facilities is a challenging task for wiring. In order to avoid “spaghetti-like” cabling, there is a tendency at present to substitute standard bus lines for single element control wiring.

In the realm of commercial vehicles, the application of the so-called “door module” has become known which is comprised of a master controller and a multi-functional controller in which the control for electrically adjustable outside mirrors, electrical window operators and the like are combined into one master entity. In doing this, the functional controller is enclosed in the hollow space of the door and the master control, which is connected to the functional control by a cable, is placed in the vehicle interior in a driver-accessible manner on the door. The necessity for close proximity of the master controller to the multi-purpose functional controller limits the flexibility of a control system of this kind.

Thus, it is the purpose of the present invention to so develop this type of control system, so that a more flexible usage thereof is possible in motor vehicles.

The achievement of this purpose is accomplished by the features of Claim 1 of the present invention.

Such a system is achieved by the invention, wherein a master control governs a plurality of subordinate controls and said master control is placed at the driver's convenience at a central position, and a plurality of electrically driven functional elements in the motor vehicle can be operated, activated and controlled. Among the said functional controls which perform specific operations, certain units corresponding to respective technical requirements, can be grouped together in a single, activating controller. For instance, where separate functional units are activated by a common master controller it is possible to bring together such functional controllers as present more complex requirements for a control system, into one, individual functional control block. Furthermore, the number of the functional controls can be optimized in the design, with consideration given to the space requirements and the locations available in the motor vehicle. A master control can be placed not only in the interior of the vehicle, but also on the outside.

The connection between the master control and the functional controls can be made as a cable in the form of electrical cable or also in the form of glass fiber cable. In accord with a particularly preferred embodiment of the invention, the communication, that is, the connection, is effected without wires between the master control and the functional controls This is done by radio or especially by infrared. By means of the wireless connection between the master control and the functional controls, the master control can be located by the driver at any convenient place, as it suits the driver's personal wishes. Moreover, the master control can also be carried on the person, whereby, in a very simple way, theft security is assured.

In accord with an advantageous embodiment of the invention, the connection, that is the communication between the master control and the functional controls, is made by means of a directed infrared beam, wherein the driver must point the emitting master control onto the respective functional control. This necessitates a personal involvement, because the driver must be able to have a sight line to the respective functional control.

In accord with yet another preferred embodiment of the invention, the master control can be removed from the functional control block and in the case of wireless communication, the said master control is carried by the driver. Further, with an appropriate shaping of the master control, it can be placed at any optional place in the vehicle.

In accord with still another preferred embodiment of the invention, a plurality of master controls is provided. In this way, one master control can remain on a key ring, through which the central locking mechanism and also other functional units can be activated from a remote position of the driver. A further master control is at a central position in the interior of the vehicle, ergonomically favorable to the driver. In this case is it also possible, that different drivers, who use one and the same vehicle, can store definite, personal presettings in the master control. An example of that might be, the positioning of the driver's seat for each respective driver, which positioning data can be stored in the particular memory reserved for that driver in the master control assigned to that driver.

In accord with a further embodiment of the invention, the master control is subdivided into the main control part and the subordinate control part. In this way, there is a division of those functional units, which must not be operated from the outside, for instance, the electric window operation mechanism, and functional units which should be operated external to the vehicle, such as the central locking system. One advantage of this is that a more compact design of the subordinate control part is possible.

By means of the flexibly formulated control system in accord with the invention, an electrically activated door locking mechanism can be made. The portable master control, or subordinate master control serves in a known manner as an infrared key for the activation of the central locking mechanism. By means of the same activation element, or by another activation element on the master control, an electrically operated locking mechanism locks or unlocks the door. In this way, a mechanical, manually activated door lock mechanism can be dispensed with, which brings about a substantial advantage in cost as a result.

The master control for the door lock mechanism can also be installed in an accessible and customary place on the outside of the vehicle door.

The remaining subordinate claims are concerned with further advantageous embodiments of the invention.

Further details, features and advantages of the invention may be found in following description of preferred embodiments with the aid of the drawing.

There is shown in:

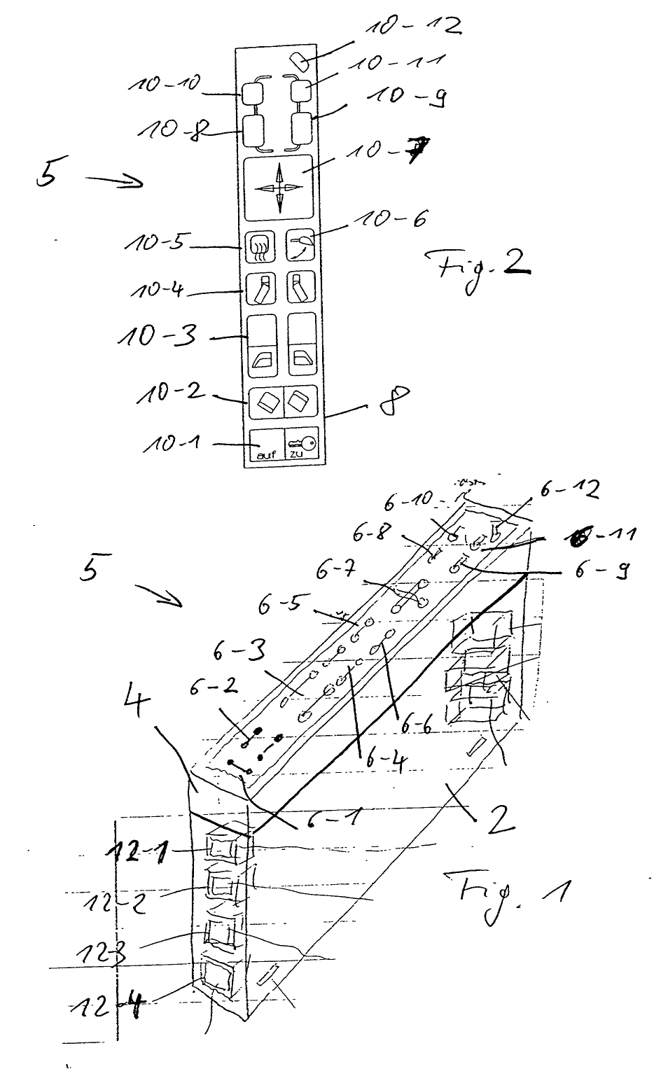

FIG. 1 a schematic presentation of a first embodiment of the invention, in which the master control can be releaseably affixed to the functional control block and the communication, that is, the connection, between the master control and the functional control block is effected by infrared or by a plug connection,

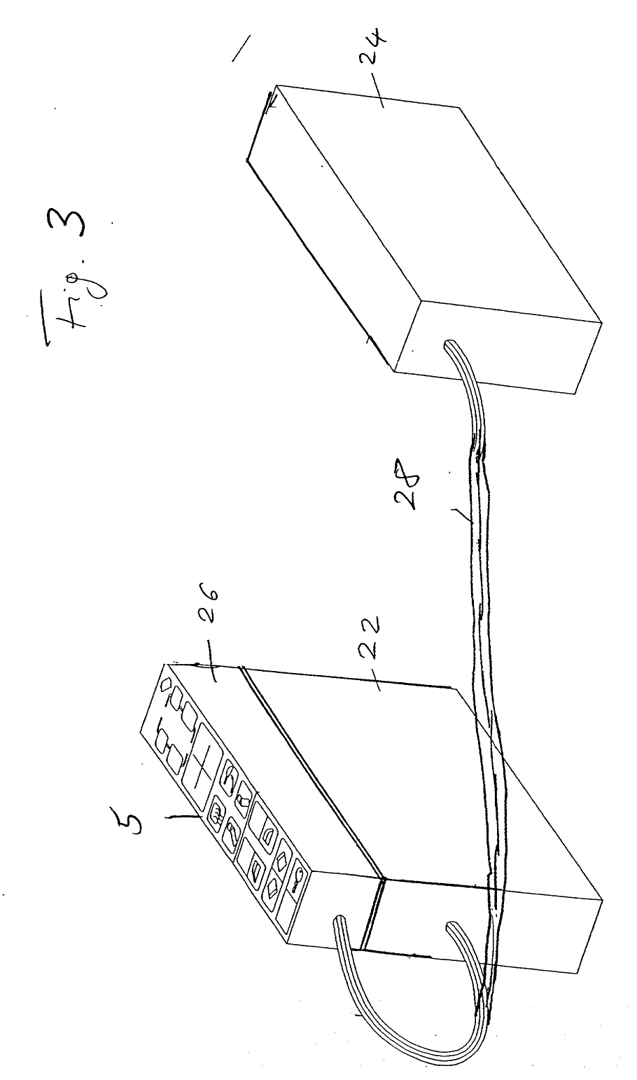

FIG. 2 an embodiment depicting the visible symbols on the master control for the corresponding functional unit,

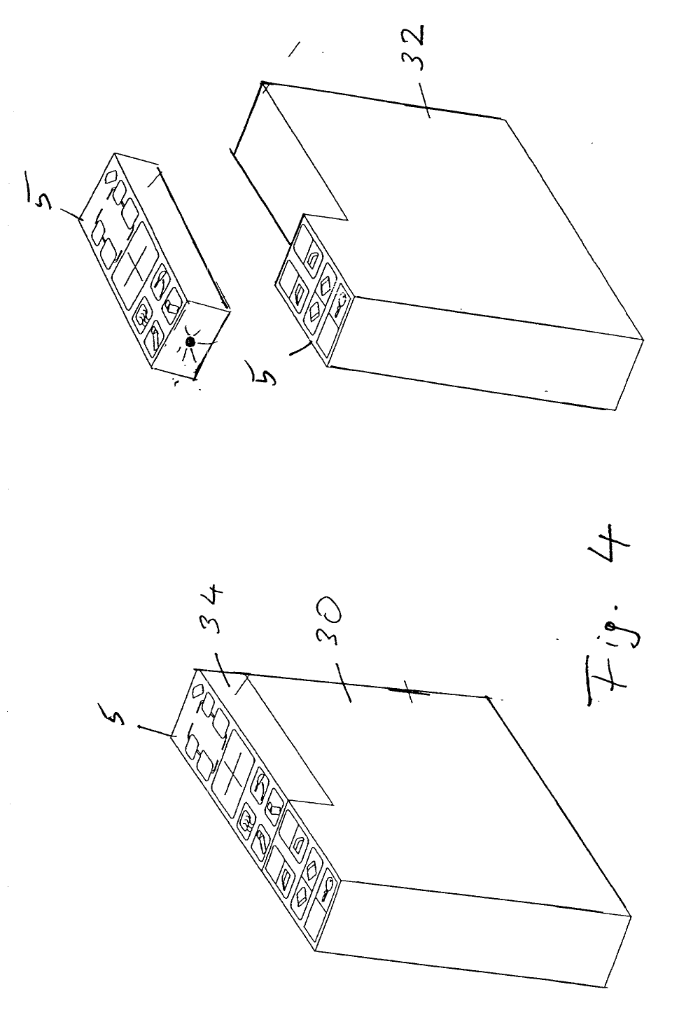

FIG. 3 a second embodiment of the invention in which the master control is connected to the functional control block by means of a cable,

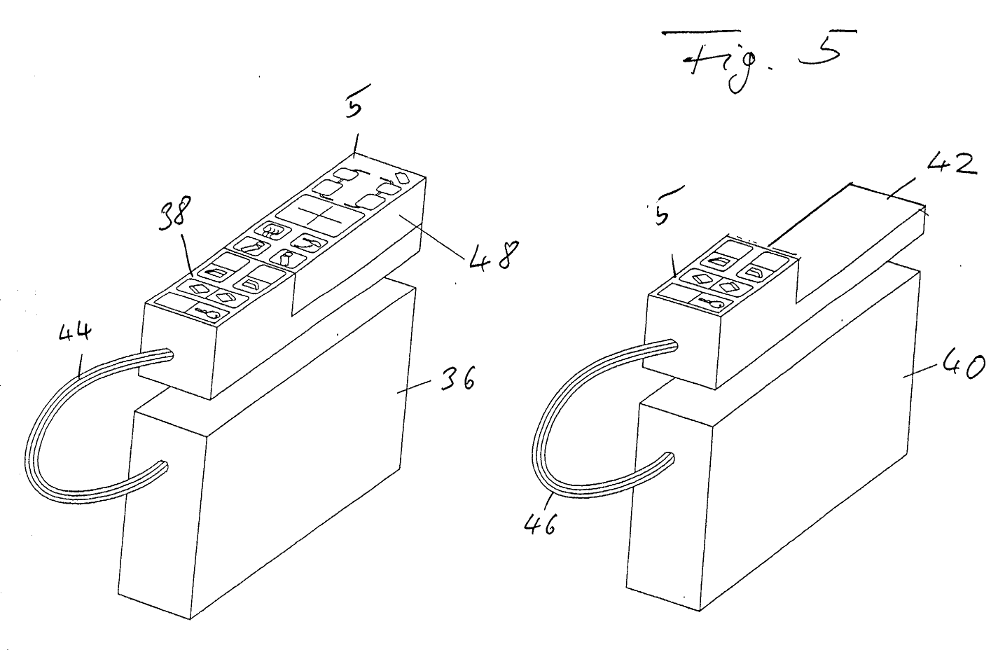

FIG. 4 a third embodiment illustration of the invention, in which a part of the master control is firmly integrated into the functional control block, and

FIG. 5 a fourth embodiment of the invention, wherein the master control is divided into a main part and a subordinate part.

Shown in FIG. 1 is a first embodiment of the control system in accord with the invention, with a functional control block 2 and a master control 4 affixed thereto by plug-in means. Both the functional control block 2 as well as the master control 4 are of rectangular cross section shape so that they conform to one another. The upper side of the master control 4, that is, that side which is remote from the functional control block 2, is designed as a membrane keyboard 5. The membrane keyboard 5 encompasses a plurality of pressure and rocker switches 6-1, which, by means of an exchangeable covering membrane, are provided with symbols 10-i for the respective switches 6-i. In FIG. 2, are shown example symbols 10-i, which are laid against the respective switches 6-i.

The symbols 10-i have the following significance, that is they activate the appropriate switches 6-i and control the following functional units:

| | | |
|---|---|---|
| 10-1, | 6-1 | Door locking |
| 10-2, | 6-2 | Sun roof opening |
| 10-3, | 6-3 | Electrical operator |
| 10-4, | 6-4 | Automatic, outside mirror adjustment on curve driving |
| 10-5, | 6-5 | Mirror heating |
| 10-6, | 6-6 | Fold retraction for outside mirror |
| 10-7, | 6-7 | Mirror Adjustment |
| 10-8, | 6-8 | Selective switch for main mirror, left |
| 10-9, | 6-9 | Selective switch for main mirror, right |
| 10-10, | 6-10 | Selective switch for wide angle mirror, left |
| 10-11, | 6-11 | Selective switch for wide angle mirror, right |
| 10-12, | 6-12 | Selective switch for the ramp mirror. |

The formulation of the symbols as well as their layout on the membrane 8, are shown in FIG. 2, that is, the space apportionment and the arrangement of the switches 6-i on the upper side of the master controller 4 are naturally only for example and can otherwise be adapted to a specific application.

In FIG. 1, showing functional control block 2, are depicted, without further description, the inserts provided for the respective functional units. A corresponding connection array 12-i thereof is externally accessible and connectable by means of cable to the corresponding functional units. Further in functional control block 2, as an example, are found connection terminals:

12-1, for the mirror bus of a ramp mirror,

12-2 a connection for the mirror bus to the main and wide angle mirror,

12-3 connection for the window operator and

12-4 a connection for the door locking. The connection array 12-i is advantageously arranged on a narrow side of the functional control block 2. On the oppositely situated narrow side of the functional control block 2 is provided a diagnostic interface 14, a connection for a vehicle CAN-Bus 16 and a connection 18 for the power supply.

The reference number 20 designates a water run-off, which is necessary in case the functional control block 2 is placed in the hollow interior of the door, which is regarded as a high humidity space.

A second control apparatus, which, for instance, would be located in the passenger side door, is not described in further detail, as it possesses the same construction as the previously described functional control block 2.

The master control 4 is releaseably affixed by means of a plug-in arrangement to the control functional block 2. The communication, that is the connection, between the master control 4 and the functional control block 2, when in the united situation, is made by the said plug-in arrangement and when the master control is separated therefrom and in a remote situation, then by infrared.

FIG. 3 shows a second embodiment of the invention, with a first functional control block 22 and a second functional control block 24, both possessing a common master controller 26. The master controller 26 is releaseably connectable with the first functional control block 22 or with the second functional control block 24 and the communication, that is, the connection, between the master controller 26 and the two functional control blocks 22 and 24 is effected by a cable 28. In general, the second embodiment corresponds to the first embodiment.

In FIG. 4 presents a third embodiment of the invention with a first, functional control block 30 to be located on the driver's side and a second functional control block 32 located on the passenger side. These are accompanied by two master controllers 34 and 35. The master controllers 34 and 35 are releaseably affixed with the first or second functional control blocks 30 or 32 and the communication, that is the connection, between master controllers 34, 35 and the two functional control blocks 30, 32 is carried out by means of an infrared connection.

Different from the first and the second embodiments, the master controllers for the door locking 6-1, sun roof opening 6-3 and window operator 6-3 are on the upper side of the two functional controller blocks 30 and 32, however, the remaining operational elements 6-4 to 6-12 are contained in the releaseable master controller 34. Naturally, even other arrangements can be chosen, for instance, the functional control of the window operator can be still integrated into the master controller 34.

FIG. 5 shows a fourth embodiment of the invention, with a first functional control block 36, a first master controller 38, and a second functional control block 40 with a second master control 42. The two master controllers 38, 42 are connected by means of cable 44, 46 to the respective functional control blocks 36, 40. One or more, subordinate, separable sections 48 of the two master controllers 38 and 42 permit the use of communication by infrared connections. The remaining portion 48 is again releaseably affixed to the respective master controller 38, 42 and is in communication therewith by means of infrared. The apportionment of the functional units between the separable section 48 and the two master controls 38 and 42, corresponds to the apportionment between the separable section 34 and the two functional controller blocks 30, 32 in the embodiment as shown in FIG. 4.

The cables 28, 44 and 46 can be electrical cables and/or optical cable.

Ref. No. Designation List

| | |
|---|---|
| 2 | Functional control block |
| 4 | Master controller |
| 5 | Membrane keyboard |
| 6-i | Functional operating elements |
| 6-1 | Door locking |
| 6-2 | Sliding roof cover, sun roof |
| 6-3 | Window operator, up, down |
| 6-4 | Memory functions for automatic mirror adjustment |
| 6-5 | Mirror heating |
| 6-6 | Outside mirror fold up mechanism |
| 6-7 | Mirror adjustment |
| 6-8 | Selective switch for main mirror, right |
| 6-9 | Selective switch for main mirror, left |
| 6-10 | Selective switch for wide angle mirror, right |
| 6-11 | Selective switch for wide angle mirror, left |
| 6-12 | Selective switch for ramp mirror |
| 8 | Membrane for keyboard |
| 10-i | Symbols for functional elements |
| 12-i | Connections for control apparatus |
| 12-1 | Connection to mirror bus, ramp mirror |
| 12-2 | Connection for mirror bus, main and wide angle mirrors |
| 12-3 | Connection for window operator |
| 12-4 | Connection to door locking |
| 14 | Diagnostic interface |
| 16 | Connection to vehicle LAN bus |
| 18 | Connection to current supply |
| 20 | Water run-off |
| FIG. 3 | |
| 22 | First functional block control |
| 24 | Second functional block control |
| 26 | Master control |
| 28 | Cable |
| FIG. 4 | |
| 30 | First functional block control |
| 32 | Second functional block control |
| 34 | First master control |
| 35 | Second master control |
| FIG. 5 | |
| 36 | First functional block control |
| 38 | First master control |
| 40 | Second functional block control |
| 42 | Second master control |
| 44 | Cable between 36 and 38 |
| 46 | Cable between 40 and 42 |
| 48 | Separable part of master control 38 |

Claimed is:

1. A control system for electrically driven functional elements in motor vehicles, especially such as central locking, window operators, outside mirrors, and the like, said control system having a master controller (4; 26; 34, 35; 38, 42, 48) and a plurality of functional control blocks (2; 22, 24; 30, 32; 36, 40) connected with the said master controller (4; 26; 34, 35; 38, 42, 48) for the activation and control of electrically driven functional units in a motor vehicle, wherein the functional control blocks are in turn connectable to the respective functional elements.

2. A control system in accord with claim 1, therein characterized, in that the master controller (26; 34; 38, 42) is connected by means of cable and/or optical conductor (28; 44, 46) with the functional control block (22, 24; 36, 40).

3. A control system in accord with claim, 1 therein characterized, in that the master controller (4; 34, 35, 48) is connected to the functional control block (2; 30, 32) without wires.

4. A control system in accord with claim 3, therein characterized, in that the master controller (4; 34, 35, 38) is connected to the functional control block (2; 22, 24; 36, 40) by means of a directed of infrared signal.

5. A control system in accord with one of the foregoing claims, therein characterized, in that the master controller (4; 26; 34, 35; 38, 42, 48) is releaseably affixed to at least one of the functional control blocks (2; 22, 24; 30, 32; 36, 40).

6. A control system in accord with one of the foregoing claims, therein characterized, in that the master controller (4; 26; 34, 35; 38, 42, 48) is releaseably placed in a central location, within reach of the driver and inside the vehicle.

7. A control system in accord with one of the foregoing claims, therein characterized, in that the functional control blocks (2; 22, 24; 30, 32; 36, 40) are located in proximity to the respective operational units.

8. A control system in accord with one of the foregoing claims, therein characterized, in that a functional control block (2; 22, 24; 30, 32; 36, 40) is designed for the control of a plurality of operational units.

9. A control system in accord with one of the foregoing claims, therein characterized, in that a plurality of master controllers (34, 35; 38, 48, 42) are connected with functional controller blocks (30, 32; 36, 40).

10. A control system in accord with claim 9, therein characterized, in that a master controller possesses a main part (38, 42) and a subordinate part (48), wherein the main part (38, 42) is connected to the functional control block (36, 40), and wherein the subordinate part (48) can be releaseably affixed to the main part (38, 42) and for the activation of a functional unit is connected without wires with the main part (38, 42) and/or directly to the respective functional control block (36, 40).

11. A control system in accord with one of the foregoing claims, therein characterized, in that, the master control (4; 26; 34, 35; 38, 42, 48) is designed as a membrane keyboard (5), which, includes pressure activated operating elements (6-i) and a covering film (8) with corresponding symbols (10-i).

12. An electrical door locking apparatus with an electrically driven door locking mechanism, which, by means of a control system, is connected in accord with one of the preceding claims.
